(19) United States
(12) Patent Application Publication
(10) Pub. No.: US 2013/0031227 A1
(43) Pub. Date: Jan. 31, 2013

(54) TRANSMISSION OF CONFIGURATION TO A DEVICE FOR PROVISIONING IN A NETWORK

(71) Applicants: Daniel E. Ford, Granite Bay, CA (US); Chuck A. Black, Rocklin, CA (US)

(72) Inventors: Daniel E. Ford, Granite Bay, CA (US); Chuck A. Black, Rocklin, CA (US)

(21) Appl. No.: 13/191,852

(22) Filed: Jul. 27, 2011

(51) Int. Cl. G06F 15/177

(52) U.S. Cl. 709/222

(57) ABSTRACT

A method is provided that includes receiving a communication from a trusted device indicating that a device to be provisioned has been added to the network; obtaining identifying information of the device to be provisioned; accessing a stored configuration for the device based on the identifying information; and transmitting the configuration to the device for provisioning. Alternatively, a computer-readable medium is provided that stores instructions to perform a method to transmit a discovery communication to a trusted device, receive a communication originating at an administrative device including a configuration; and provision the device via reboot with the configuration. Alternatively, an apparatus is provided including a table of provisioning configurations, the table including a configuration for a device to be provisioned in a network and a provisioning module to retrieve the configuration of the device stored in the table of provisioning configurations based on identifying information received from a discovery communication.

### BACKGROUND

In order for a device to operate in a network, the device may need to be configured thereby provisioning it in the network. The configuration for the device may differ based on where the device is to be located in the network, and what types of functions the device is to perform. Typically, the device may be configured by an administrator, and then repackaged and shipped to a remote location where the device may be physically located within the network. Additional steps may be taken at the remote location to connect the device to the network in order to have the device function as desired.

### DRAWINGS

FIG. 1. is an example diagram of a system environment, in accordance with an example embodiment of the present disclosure.

FIG. 2 is an example block diagram of an administrative device, in accordance with an example embodiment of the present disclosure.

FIG. 3 is an example flow diagram of a method for transmitting a stored configuration, in accordance with an example embodiment of the present disclosure.

FIG. 4 depicts an example flow diagram of a method for provisioning of a device, in accordance with an example embodiment of the present disclosure.

FIG. 5 depicts an example flow diagram of a method for forwarding a communication including a configuration, in accordance with an example embodiment of the present disclosure.

### DETAILED DESCRIPTION

When adding a device to a network, typically an administrator at a central office may order the device from a manufacturer and have it shipped to the central office. The administrator may unpack the device, pre-provision the device by downloading a configuration to the device, repack the device, and ship the device to a location where the device is to be installed in the network. The administrator may then provide instructions to a technician at the location where the device is to be installed and trust that the technician may install the device correctly.

### Overview

As discussed herein, a device may be provisioned while the device is attached to the network at the location where the device will be operating. The device may be connected to a trusted device. When connected to a network, the device to be provisioned may transmit, through a discovery communication, identifying information of the device to be provisioned to the trusted device. The trusted device may receive the discovery communication and transmit information to an administrative device indicating that the device to be provisioned has been added to the network. The administrative device may obtain identifying information of the device to be provisioned from the trusted device. The administrative device may access a stored configuration for the device to be provisioned based on the obtained identifying information. The accessed configuration may be transmitted to the device to be provisioned through the trusted device. Upon receipt of the transmitted configuration, the device to be provisioned may reboot with the configuration, wherein the device may be provisioned in the network.

This allows an administrator at a central site to pre-provision a device by storing a configuration for a device to be provisioned based on, for example, where the device will be operating the network, what functions the device may perform, etc. The configuration may be stored such that when the device to be provisioned is connected to the network, the configuration may be accessed, transmitted to the device to be provisioned and the device may reboot with the configuration thereby provisioning the device within the network.

### System Environment

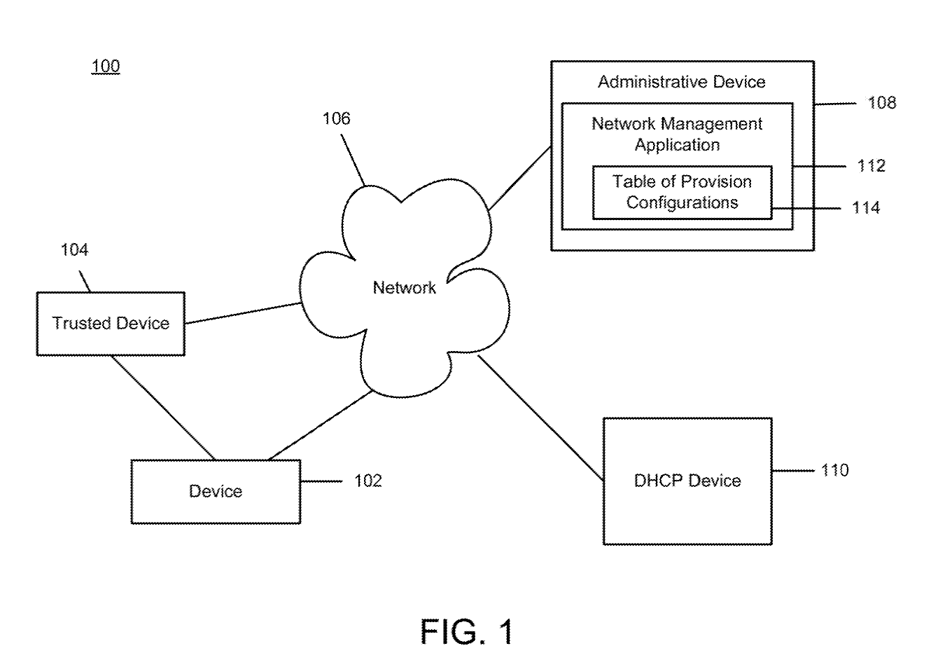

FIG. 1. depicts a diagram of a network including system environment 100. System environment 100 includes a device, i.e., device to be provisioned 102, a trusted device 104, an administrative device 108, and a dynamic host configuration protocol (DCHP) device 110, in accordance with an example embodiment of the present disclosure. Device 102 and trusted device 104 may be physically located at the same office site of the administrative device 108, or may be physically located at an office site remote from the location of the administrative device 108. The devices in system 100 may communicate with each other through network 108. It may be appreciated that while only four devices and one network are depicted in FIG. 1, other devices and networks may reside within the system environment 100.

Network 106 may be implemented as any wide area network (WAN) or local area network (LAN) in accordance with the functionality as discussed herein. For example, network 106 may be implemented as any wired or wireless network, including an enterprise network, wideband code division multiple access (WCDMA), personal communication services (PCS), worldwide interoperability for microwave access (WiMAX), local area network (LAN), wide area network (WAN), etc.

Device 102, which may be implemented as, for example, a switch, router, hub, access point, controller, or any other device that may need to be configured, provisioned, etc., within system environment 100. Device 102 may communicate with trusted device 104, administrative device 108, and DCHP device 110.

Trusted device 104 may be implemented as, for example, a switch, router, hub, access point, controller, etc., and may be trusted in that it is already provisioned within system environment 100. Device 104 may be able to communicate with device 102, administrative device 108 and DHCP device 110. Trusted device 104 may include a simple network management protocol (SNMP) agent that may communicate with other SNMP agents at devices, for example, device 102, administrative device 108, etc., within the system environment 100.

Administrative device 108 may be implemented as a computing device, for example a server, etc., and may administer devices within system environment 100. Administrative device 108 may include a network management application 112. Administrative device 108 may further include a table of provision configurations 114. Network management application 112 may create, access, modify, delete, etc., data stored in the table of provision configurations. The table of provision configurations may store configuration files that may be used to provision devices within system environment 100. Administrative device 108 may communicate with trusted device 104 and device 102.

DCHP device 110 may be implemented as a computing device, for example, a server, etc., and may be used to manage, assign, etc., internet protocol (IP) addresses to devices within system environment 100.

### Administrative Device Configuration

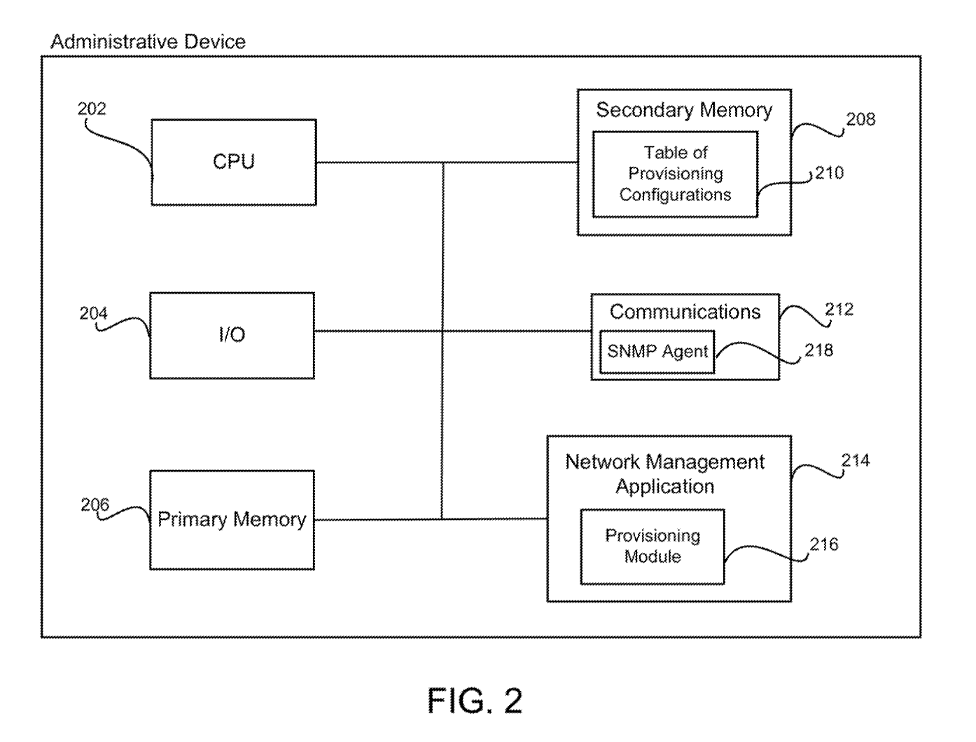

FIG. 2 depicts an example administrative device 108 configuration in accordance with an example embodiment. As shown in FIG. 2, administrative device may include a central processing unit 202, input/output devices 204, memory 206, secondary memory 208, communications 212 and network management application 214.

Secondary memory 208 may include a table of provision configurations 210. The table of provision configurations 210 may store a configuration file that may be used to provision a device that is to be added to system environment 100. The configuration file may be associated with identifying information of the device to be provisioned, for example, a model name, a device serial number, an internet protocol (IP) address, a model type, location of the device within the system environment 100, etc. The configuration file may further be associated with information identifying a trusted device that the device may be connected to, for example, a model type of the trusted device, a port that the device should be connected to, a location of the trusted device within system environment 100, etc. The table of provision configurations 210 may be accessible by network management application 214.

Network management application 214 may include a provisioning module 216. Provisioning module 216 may facilitate communication with the device 102 to be provisioned through a trusted device 104, may access the table of provision configurations and may transmit the accessed configuration to the device 102 for provisioning within system environment 100, as may be more fully discussed below.

The administrative device 108 may be implemented through any suitable combinations of software including machine readable instructions, firmware, including machine readable instructions, and/or hardware. Secondary memory may be implemented within the device and/or may be implemented as external data storage. Primary and/or secondary memory may be computer-readable mediums configurable to store applications as discussed herein. Primary and/or secondary memory may further be configurable to receive an installation pack from an external memory, for example, a portable computer-readable medium, for example, a Compact Disc/Digital Video Disc, etc.

Communications 212 may enable communication with other devices utilizing wired and/or wireless communication protocols. Input/output devices 204 may include a display, a user input device, for example, keyboard, touch screen, mouse, etc. to facilitate user interaction with a user interface. Communications 212 may include SNMP agent 218 and may exchange communications with other SNMP agents located on other devices within the system environment 100.

### System Flow

When a device 102 is to be provisioned within a system environment, the device 102 may be shipped directly from the manufacturer to the site where the device is to be installed. An administrator, at an administrative device 108, may create a configuration file that may be used to provision the device based on where the device is to be positioned and what functions the device is slated to perform within the system environment. The provisioning module 216 may enable creation and storage of a record in the table of provision configurations 210. The record may include the configuration file and identifying information the device to be provisioned. The record may further including identifying information of the trusted device that the device is to be connected to. This information may be used to determine which configuration file to select and access.

When the device 102 is connected to the trusted device 104 in the system environment 100, the device 102 communicates with the DHCP server 110 to obtain an IP address. The DHCP server 110 assigns the IP address to the device 102 and/or communicates the assigned IP address to the device 102.

The device 102 sends a discovery communication to the trusted device 104. The discovery communication may include identifying information of the device 102, for example, IP address, model name, model type, etc. This discovery communication may be transmitted using link layer discovery protocol (LLDP), Cisco discovery protocol (CDP), foundary protocol, service location protocol, or any other discovery protocol that provides identifying information to the trusted device 104.

The trusted device 104 receives the discovery communication and transmits a communication to the administrative device 108 indicating that the device has been added to the network. The administrative device 108 may query the trusted device for identifying information about the device that has been added to the network and/or additional information about the trusted device, for example, the trusted device name, trusted device model type, the location of the trusted device, identifying information about the port the device is connected to, etc.

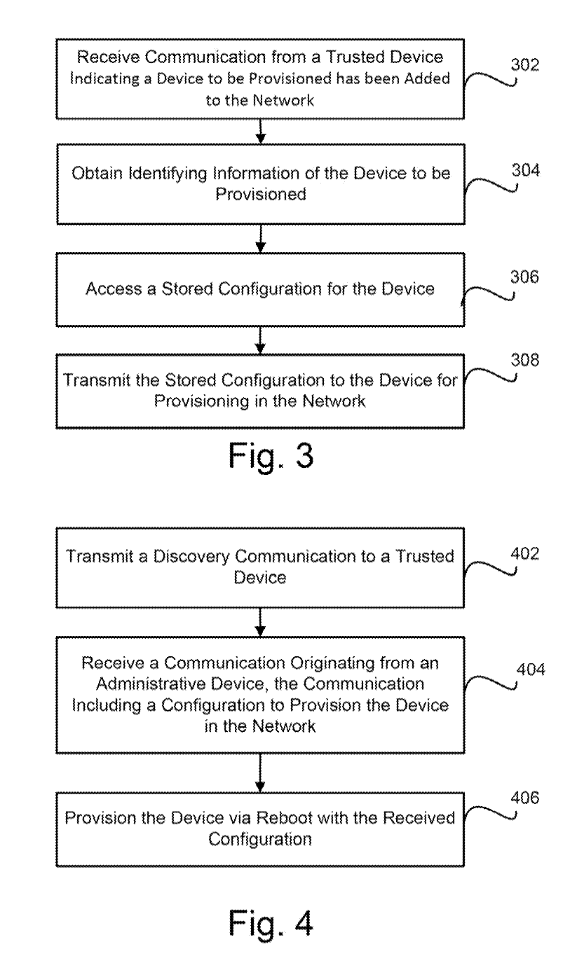

FIG. 3 depicts an example flow diagram of a method performed by the administrative device 108, in accordance with and example embodiment. As shown in FIG. 3, the administrative device receives a communication from the trusted device. The communication may indicate a device to be provisioned has been added to the network (Step 302). The administrative device, through its agent, may then obtain, from the trusted device, through one or more subsequent communications between the administrative device and the trusted device, identifying information of the device to be provisioned (Step 304). This may be accomplished, for example, by the administrative device querying the trusted device for identifying information of the device that has been added to the network (the device to be provisioned). This identifying information may be stored in one or more tables at the trusted device as more fully discussed below.

Upon receipt of the identifying information, the provisioning module may parse the received communication for the identifying information. A stored configuration for the device to be provisioned may be accessed (Step 306). For example, the provisioning module of the administrative device may access the table of provision configurations in order to select and access the configuration for the device to be configured.

For example, the identifying information may merely be an IP address of the device to be provisioned. Based on the IP address, the provisioning module may access the configuration file associated with the IP address in the table of provision configurations. Alternatively, using the IP address, the administrative device may transmit a request for additional identifying information to the device to be provisioned, through the trusted device. Upon receipt of the response to the request, the response to the requesting including additional information, for example, the model name, the model type, etc., the configuration file may be accessed.

For another example, the identifying information may include the model type of the device to be configured. Based on the model type and information identifying the trusted device, for example, the location of the trusted device, the model name, the model type, etc., the configuration file may be selected and accessed in the table of provision configurations.

It may be appreciated that any identifying information of the device 102 and/or trusted device 104 that was received from the trusted device 104 may be used to identify the configuration for the device 102.

The stored configuration may be transmitted to the device for provisioning in the network (Step 308). The stored configuration file accessed from the table of provision configurations may be transmitted to the device through the trusted device.

FIG. 4 depicts an example flow diagram of a method performed by a device to be provisioned in a network, in accordance with an example embodiment. As shown in FIG. 4, a device may transmit a discovery communication to a trusted device (Step 402). The discovery communication may be transmitted via link LLDP, CDP, foundary protocol, service location protocol, or any other discovery protocol that provides identifying information to the trusted device.

This discovery communication may be transmitted after the device to be provisioned in the network has received an IP address from the DHCP device.

In response to the discovery communication, the device may receive a communication from the administrative device. The communication may include a configuration file to provision the device in the network (Step 404).

The communication from the administrative device may be routed through the trusted device to the device to be provisioned.

The device may then initiate a reboot process with the received configuration (Step 406). Upon completion of the reboot process, the device is provisioned and fully functional within the network. The device may perform the functionality in accordance with the configuration defined in the configuration file.

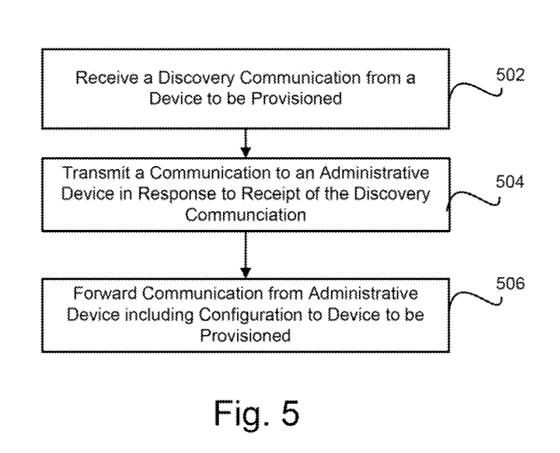

FIG. 5 depicts an example flow diagram of a method performed at a trusted device, in accordance with an example embodiment. As shown in FIG. 5, the trusted device received a discovery communication from a device to be provisioned in a network (Step 502).

The trusted device sends a communication to the administrative device in response to receipt of the discovery communication (Step 504).

For example, the trusted device may store in one or more tables information identifying neighboring devices. The trusted device may send a communication, for example, a simple network management protocol (SNMP) trap communication. The communication may be between SNMP agents, one agent located at the trusted device, another agent located at the administrative device, for example, in communications 212. An example of the communication may be as follows:

```
lldpNotificationPrefix OBJECT IDENTIFIER ::= { lldpNotifications 0 }
lldpRemTablesChange NOTIFICATION-TYPE
  OBJECTS {
    lldpStatsRemTablesInserts,
    lldpStatsRemTablesDeletes,
    lldpStatsRemTablesDrops,
    lldpStatsRemTablesAgeouts
  }
  STATUS current
  DESCRIPTION
      “A lldpRemTablesChange notification is sent when the value
      of lldpStatsRemTableLastChangeTime changes. It can be
      utilized by an NMS to trigger LLDP remote systems table
      maintenance polls.
    Note that transmission of lldpRemTablesChange
    notifications are throttled by the agent, as specified by the
    ‘lldpNotificationInterval’ object.”
::= { lldpNotificationPrefix 1 }
```

As can be seen from the above, the communication from the trusted device to the administrative device may include counters to indicate what changes have been detected by the trusted device, including devices that have been added (“inserts”) to the “neighbor table” that is stored and maintained at the trusted device. Additional communications may be received from the administrative device requesting additional identifying information about the device that has been added. This information may be “Remote Systems Data” stored in, for example, the trusted device's “lldpRemTable” mib object. This table may include a port index, macAddress, sysName, SysDescriptor, Management address (IP address), etc. One or more of this information may be used by the administrative device to identify a configuration in the Table of Provision Configurations to be sent to the device to be provisioned.

The trusted device may receive a communication from the administrative device, addressed to the device to be provisioned in the network. The communication may include the configuration for the device to be provisioned. The trusted device may forward the communication including the configuration to the device to be configured (Step 506).

Additional steps may be performed in order to provide additional security to the network as the device 102 is being provisioned in the network. For example, the administrative device may perform security authentication checks to verify certificates that may be installed at device 102 for device identification and verification. This may be accomplished by the administrative device sending a request for verification of the identification certificate at the device 102 before the configuration file is transmitted to the device 102. If identification cannot be made, the administrative device may not transmit the configuration file to the device 102.

### Alerts

As noted above, in the table of provision configurations, the stored configuration file for a device to be provisioned in the network may have associated therewith information regarding how the device should be connected to the trusted device. For example, if the device to be provisioned should be connected to a particular port of the trusted device, the port number of the trusted device may be stored in association with the configuration file.

When the communication is received by the administrative device including the port number that the device to be provisioned is connected to, the provisioning module may access the record storing the configuration file associated with the identifying information of the device to be provisioned. The provisioning module may compare the received port number that the device is physically connected to with the stored port number associated with the accessed configuration. If the received port number is different, then an alert may be generated and sent to an administrative device (not shown in FIG. 1) at the site where the trusted device is physically located. The alert may include information that the device to be provisioned is not properly connected to the trusted device, for example, the device to be provisioned is connected to an incorrect port. The alert may further include information instructing a user at the site where the trusted device is physically located to properly connect the device to be provisioned.

It may be appreciated that the provisioning module may transmit the configuration file to the device to be provisioned even if the device is not properly connected to the trusted device.

Alternatively, the provisioning module may generate and send the alert to the administrative device at the site where the trusted device is located and wait for another communication from the trusted device indicating that the device to be provisioned is properly connected to the trusted device. Once the device to be provisioned is properly connected to the trusted device, the administrative device may then transmit the communication including the configuration to the device for provisioning in the network.

We claim:

1. A method, comprising:
receiving a communication from a trusted device indicating that a device to be provisioned has been added to a network;
obtaining, from the trusted device, identifying information of the device to be provisioned;
accessing a stored configuration for the device to be provisioned based on the obtained identifying information; and
transmitting the accessed stored configuration to the device to be provisioned for provisioning in the network.

2. The method of claim 1, wherein the identifying includes an internet protocol (IP) address of the device to be provisioned and the stored configuration is accessed based on the IP address of the device to be provisioned.

3. The method of claim 2, further comprising:
transmitting a request for information to the device to be provisioned through the trusted device; and
receiving a response to the request for information, the request including additional information identifying the device to be provisioned, wherein the stored configuration is accessed based on the additional information received from the device to be provisioned.

4. The method of claim 1, further comprising:
storing a table of provisioning configurations, the table including the configuration for the device to be provisioned, identifying information of the device to be provisioned associated with the configuration, and identifying information of the trusted device associated with the configuration;
wherein the accessing a stored configuration comprises:
referencing the table of provisioning configurations to identify the configuration of the device to be provisioned based on the received identifying information of the device to be provisioned.

5. The method of claim 4, wherein the accessing a stored configuration further comprises:
determining that the device to be provisioned is properly connected to the trusted device based on identifying information of the trusted device received in the communication.

6. The method of claim 1, further comprising:
determining the device to be provisioned is connected to an incorrect port at the trusted device based on information obtained from the trusted device; and
transmitting a communication to an administrative device including information that the device to be provisioned is connected to an incorrect port at the trusted device.

7. The method of claim 6, wherein the accessed stored configuration is transmitted to the device to be provisioned when it is determined that the device to be provisioned is connected to a correct port of the trusted device.

8. The method of claim 1, wherein the communication received from the trusted device indicating that the device to be provisioned has been added to the network is a simple network management protocol communication.

9. The method of claim 1, further comprising:
transmitting a request for verification of identification of the device to provisioned, wherein the configuration is transmitted to the device to be provisioned when the identification of the device to be provisioned is verified.

10. A non-transitory computer-readable medium, storing a set of instructions, executable by a processor, to perform a method to:
transmit, from a device, a discovery communication to a trusted device in a network, the discovery communication including identifying information;
receive, from the trusted device, a communication originating at an administrative device, the communication including a configuration to provision the device in the network; and
provision the device by via reboot with the received configuration.

11. The non-transitory computer-readable medium of claim 10, wherein the identifying information an internet protocol address.

12. The non-transitory computer-readable medium of claim 10, the method further to:
receive a request for additional identifying information from the trusted device, the request originating at the administrative device; and
transmitting a response to the request including the additional identifying information to the administrative device through the trusted device, the additional information including device model type.

13. The non-transitory computer-readable medium of claim 10, wherein the discovery communication is one of a link layer discovery protocol discovery communication and a Cisco discovery protocol discovery communication.

14. The non-transitory computer-readable medium of claim 10, further comprising:
transmitting a request to a dynamic host configuration protocol device for an internet protocol (IP) address; and
receiving a response to the request, the response including the IP address, wherein the IP address is transmitted in the discovery communication to the trusted device.

15. An apparatus, comprising:
a memory to store a table of provisioning configurations, the table including a configuration for a device to be provisioned in a network, identifying information of the device associated with the configuration, and identifying information of a trusted device associated with the configuration; and
a provisioning module to retrieve the configuration of the device to be provisioned stored in the table of provisioning configurations based on identifying information of the device to be provisioned received from the trusted device, the provisioning module further to transmit the accessed configuration through the trusted device to the device to be provisioned for provisioning.

16. The apparatus of claim 15, wherein
the identifying information of the device to be provisioned in the table of provisioning configurations includes one of an internet protocol address and a model type.

17. The apparatus of claim 15, further comprising:
an agent to receive a discovery communication from a trusted device, the discovery communication indicating that a device to be provisioned has been added to the network and to receive a communication including identifying information of the trusted device,
wherein the provisioning module parses the communication for the identifying information of the device to be provisioned.

18. The apparatus of claim 17, wherein the provisioning module is further to determine, based on identifying information, that the device to be provisioned is connected to an incorrect port of the trusted device and to generate and transmit an alert to an administrative device including information related to the device to be provisioned being connected to the incorrect port of the trusted device.

19. The apparatus of claim 18, wherein the provisioning module is further to determine that the device to be provisioned is connected to a correct port, wherein the accessed stored configuration is transmitted to the device to be provisioned when it is determined that the device to be provisioned is connected to the correct port of the trusted device.

20. The apparatus of claim 15, wherein the provisioning module is further to transmit a request for verification of identification of the device to provisioned, wherein the configuration is transmitted to the device to be provisioned when the identification of the device to be provisioned is verified.
